(19) United States
(12) Patent Application Publication
(10) Pub. No.: US 2026/0079998 A1
(43) Pub. Date: Mar. 19, 2026

(54) MULTI-CHANNEL INSIGHT EXTRACTION AND ACTION GENERATION

(71) Applicant: Salesforce, Inc., San Francisco, CA (US)

(72) Inventors: Ankit Oberoi, Hyderabad (IN); Nimesh Gupta, Bangalore (IN); Narendra Naidu Lolugu, Hyderabad (IN); Ritesh Ritesh, Bangalore (IN); Ajay Singh, Bangalore (IN); Ramprasadh Kothandarama, Hyderabad (IN)

(21) Appl. No.: 19/042,417

(22) Filed: Jan. 31, 2025

(30) Foreign Application Priority Data
Sep. 16, 2024 (IN) 202441069840

(51) Int. Cl. G06F 16/353; G06F 16/3332; G06F 16/34; G06F 40/295

(52) U.S. Cl. CPC G06F 16/353; G06F 16/345

(57) ABSTRACT

A system may store data from data channels in a first data storage, where the data from each data channel corresponds to a channel-specific structure. The system may transform the data from a channel-specific structure into a common structure to obtain transformed data and store the transformed data in a second data storage. The system may store, in a data model, a channel-specific session and one or more channel-specific threads that are in association with the transformed data. Further, a channel-specific session may correspond to metadata representing a grouping of channel-specific threads. The system may generate, in accordance with a stored configuration and via machine learning models, insights on the transformed data stored and store the insights in the data model, where an insight may be associated with the channel-specific session and the channel-specific threads of the transformed data. The system may then execute actions based on the insight generation.

### CROSS REFERENCE

The present Application for Patent claims the benefit of and priority to Indian Patent Application No. 202441069840 by Kothandaraman et al., entitled “MULTI-CHANNEL INSIGHT EXTRACTION AND ACTION GENERATION,” filed Sep. 16, 2024, assigned to the assignee hereof, and is expressly incorporated by reference in its entirety herein.

### FIELD OF TECHNOLOGY

The present disclosure relates generally to database systems and data processing, and more specifically to multi-channel insight extraction and action generation.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some examples, the cloud platform may collect feedback or data from customers to support CRM solutions. For example, the cloud platform may collect customer feedback and interaction data from multiple different data channels that are associated with different data structures. After collecting the customer feedback and interaction data, the cloud platform may generate one or more insights on the feedback and interaction data. However, due to the data being collected from various data channels that have different data structures, the cloud platform may be unable to efficiently and reliably synthesize the feedback and interaction data to generate insights on the data.

### BRIEF DESCRIPTION OF THE DRAWINGS

FIG. 1 illustrates an example of a data processing system that supports multi-channel insight extraction and action generation in accordance with aspects of the present disclosure.

FIG. 2 shows an example of a system architecture that supports multi-channel insight extraction and action generation in accordance with aspects of the present disclosure.

FIGS. 3 and 4 show an example of a computing system that supports multi-channel insight extraction and action generation in accordance with aspects of the present disclosure.

FIGS. 5 and 6 shows an example of a user interface that supports multi-channel insight extraction and action generation in accordance with aspects of the present disclosure.

FIG. 7 shows an example of a process flow that supports multi-channel insight extraction and action generation in accordance with aspects of the present disclosure.

FIG. 8 shows a block diagram of an apparatus that supports multi-channel insight extraction and action generation in accordance with aspects of the present disclosure.

FIG. 9 shows a block diagram of an insight extraction and action generation service that supports multi-channel insight extraction and action generation in accordance with aspects of the present disclosure.

FIG. 10 shows a diagram of a system including a device that supports multi-channel insight extraction and action generation in accordance with aspects of the present disclosure.

FIG. 11 shows a flowchart illustrating methods that support multi-channel insight extraction and action generation in accordance with aspects of the present disclosure.

### DETAILED DESCRIPTION

In some examples, organizations may collect customer feedback and interaction data from multiple different data channels. For example, an organization may collect customer feedback and interaction data from customer reviews, social media, call data, emails, employees of the organization, surveys, point of sale kiosks, focus groups, blogs and forum posts, affiliates with the organization, or any combination thereof. However, organizations may experience difficulties in enhancing customer experiences from the collected customer feedback and interaction data due to the collection being fragmented (e.g., separated) between the various different data channels. In some cases, computer programs may be available to gather and analyze data from the various different data channels. However, organizations may be unable to use such computer programs to generate insights on the data and to perform actions to improve the customer experience and customer satisfaction based on the insights.

The techniques of the present disclosure describes a system that integrates user (e.g., customer) feedback from various data channels to provide real-time insights on the user feedback and to facilitate the execution of one or more actions in response to the insights. For example, after receiving a set of data items (e.g., the data items including the user or customer feedback and interaction data) from a set of data channels (e.g., different sources that the data is collected from), the system described herein may ingest the set of data items in a first ephemeral data storage. Further, the data items from each data channel of the set of data channels may correspond to a channel-specific data structure. The system may then transform the set of data items from a respective channel-specific data structure into a common data structure to obtain a set of transformed data items and then store the set of transformed data items in a second ephemeral data storage. After storing the transformed data items in the second ephemeral data storage, the system may store a channel-specific session and one or more channel-specific threads corresponding to the channel-specific session that is in association with each transformed data item of the set of data items in a first data model (e.g., a cloud platform) Moreover, a respective channel-specific session may correspond to metadata representing a grouping of channel-specific threads. Further, the system may generate, in accordance with a stored configuration and via one or more machine learning (ML) models, a set of insights on the set of transformed data items stored within the first data model. A respective insight may be associated with the channel-specific session and the one or more channel-specific threads of a respective transformed data item and the system may store the set of insights within the first data model. After storing the set of insights within the first data model, the system may then execute one or more actions based on the generation of the set of insights on the set of data items. Therefore, the system may be capable of collecting data from multiple data channels associated with different channel-specific data structures, synthesizing the data into a common data structure such that insights can be generated on the data, and then executing one or more actions based on the data. Thus, in accordance with the techniques of the present disclosure, the system described herein may enable organizations to automatically execute actions from insights generated from data collected from different data channels in a more efficient and reliable manner to provide an improved user experience to the users.

In some examples, the one or more actions may include the generation of a user interface or dashboard that can display the set of generated insights. For example, in response to the system generating the set of insights, a dashboard that displays the insights may be displayed for a user of an organization. In some cases, the dashboard may include one or more interactive elements that are associated with respective insights such that the user can trigger additional actions. For example, if an element of the dashboard is displaying a respective insight for a respective group of users or customers, a user may be capable of selecting the insight to trigger an electronic message to be sent to the group of customers. In some other examples, the one or more actions may include automatically generating a summary of the set of insights, an electronic message that is associated with the set of insights, or both. Further, in some cases, the one or more actions may be executed based on a threshold being satisfied. Additionally, or alternatively, the set of insights may be generated via a set of ML models that may include large language models (LLMs), natural language processing (NLP) models, or a combination thereof.

Aspects of the disclosure are initially described in the context of an environment supporting an on-demand database service. Additional aspects of the disclosure are described with reference to a system architecture, computing systems, user interfaces, and a process flow. Aspects of the disclosure are further illustrated by and described with reference to apparatus diagrams, system diagrams, and flowcharts that relate to multi-channel insight extraction and action generation.

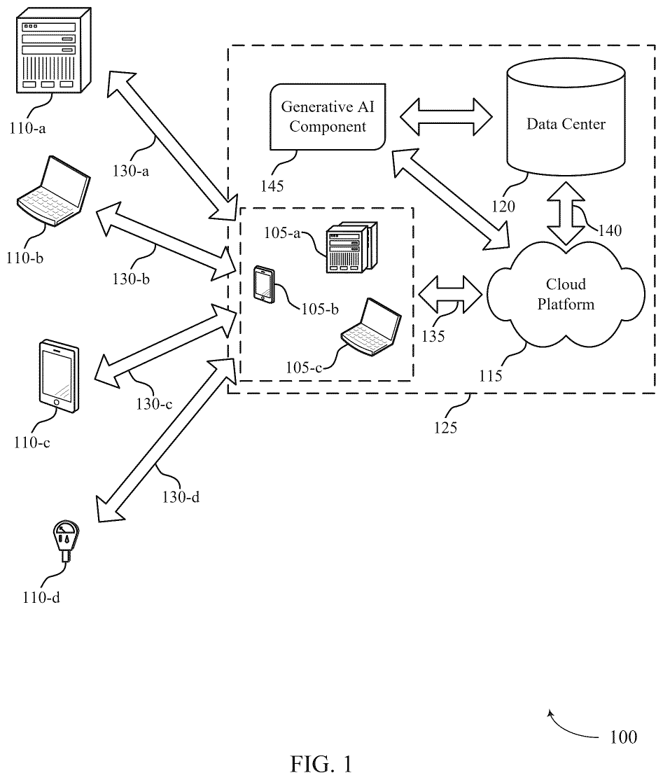

FIG. 1 illustrates an example of a system 100 for cloud computing that supports multi-channel insight extraction and action generation in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the system 100 may support the use of a LLM (generative AI model), such as the generative AI component 145. In some examples, a generative AI component 145 may also be referred to as any of an artificial intelligence (AI), a generative AI (GAI), a GAI model, a LLM (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, the generative AI component 145 may be employed by multiple components to perform one or more of the actions described as being performed by the generative AI component 145 (e.g., a single component). Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, organizations may collect customer feedback and interaction data from multiple different data channels. For example, an organization may collect (e.g., via cloud clients 105 and contacts 110) customer feedback and interaction data from customer reviews, social media, call data, emails, employees of the organization, surveys, point of sale kiosks, focus groups, blogs and forum posts, affiliates with the organization, or any combination thereof. However, organizations may experience difficulties in enhancing customer experiences from the collected customer feedback and interaction data due to the collection being fragmented (e.g., separated) between the various different data channels. In some cases, computer programs may be available to gather and analyze data from the various different data channels. However, organizations may be unable to use such computer programs to generate insights on the data and to perform actions to improve the customer experience and customer satisfaction based on the insights.

The techniques of the present disclosure may describe techniques for enabling the system 100 to integrate user (e.g., customer) feedback from various data channels to provide real-time insights on the user feedback and to facilitate the execution of one or more actions in response to the insights. For example, after receiving a set of data items (e.g., the data items including the user or customer feedback and interaction data) from a set of data channels (e.g., different sources that the data is collected from), the system 100 described herein may ingest the set of data items in a first ephemeral data storage. Further, the data items from each data channel of the set of data channels may correspond to a channel-specific data structure. The system may then transform the set of data items from a respective channel-specific data structure into a common data structure to obtain a set of transformed data items and then store the set of transformed data items in a second ephemeral data storage. After storing the transformed data items int the second ephemeral data storage, the system may store a channel-specific session and one or more channel-specific threads corresponding to the channel-specific session that is in association with each transformed data item of the set of data items in a first data model that is within the cloud platform 115.

Moreover, a respective channel-specific session may correspond to metadata representing a grouping of channel-specific threads. Further, the system 100 may generate, in accordance with a stored configuration and via one or more ML models, a set of insights on the set of transformed data items stored within the first data model. A respective insight may be associated with the channel-specific session and the one or more channel-specific threads of a respective transformed data item and the system may store the set of insights within the first data model. After storing the set of insights within the first data model, the system 100 may then execute one or more actions based on the generation of the set of insights on the set of data items. Therefore, the system 100 may be capable of collecting data from multiple data channels associated with different channel-specific data structures, synthesizing the data into a common data structure such that insights can be generated on the data, and then executing one or more actions based on the data. Thus, in accordance with the techniques of the present disclosure, the system 100 described herein may enable organizations to automatically execute actions from insights generated from data collected from different data channels in a more efficient and reliable manner to provide an improved user experience to the users.

For example, an organization associated with sales may collect data from a wide variety of different data channels to collect user feedback and interaction data. In some examples, the data may be collected directly from customers via surveys (e.g., a first data channel) and indirectly through a communication session between salespeople about a specific product (e.g., a second data channel). In some cases, the first data channel and the second data channel may each have a channel-specific data structure that is different from the other. To ensure that accurate and reliable insights can be generated, the system 100 may ingest the data from the first data channel and the second data channel and transform the data into a common data structure such that channel-specific sessions and corresponding channel-specific threads can be stored in a data model within the cloud platform 115. In some cases, for the surveys, a channel-specific session may be associated with a specific user and the one or more channel-specific threads may correspond to the data from surveys that the specific user has completed. Further, for the second data channel, the channel-specific session may correspond to the overall communication session between the salespeople and the channel-specific threads may correspond to the individual messages. The system 100 may then generate various different insights on the one or more channel-specific threads corresponding to the channel-specific session for the first data channel and for the second data channel. For example, for the first data channel, the insights may indicate that based on all the surveys completed by the user, the user is relatively happy with products of an organization except for a few specific products. Further, for the second data channel, the insights may indicate that salespeople frequently discuss receiving negative feedback on the same products. Thus, based on receiving the insights for the different channel-specific sessions and corresponding channel-specific threads, the system 100 may then determine to execute one or more actions. For example, the system 100 may execute an action to transmit an electronic message to the user who responded negatively in a survey for a product indicating that the organization is aware of an issue with the product or to provide a solution to an issue that the user is having that resulted in the negative survey response. In another example, the system 100 may execute an action to show the salespeople which types of users are providing negatively reviews based on the reviews collected from the salespeople and the reviews from surveys. Therefore, the techniques of the present disclosure may enable users and organizations to collect feedback from various indirect and direct data channels more efficiently and accurately to enable the system 100 to automatically execute actions based on insights from the feedback, thus providing an enhanced user experience.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

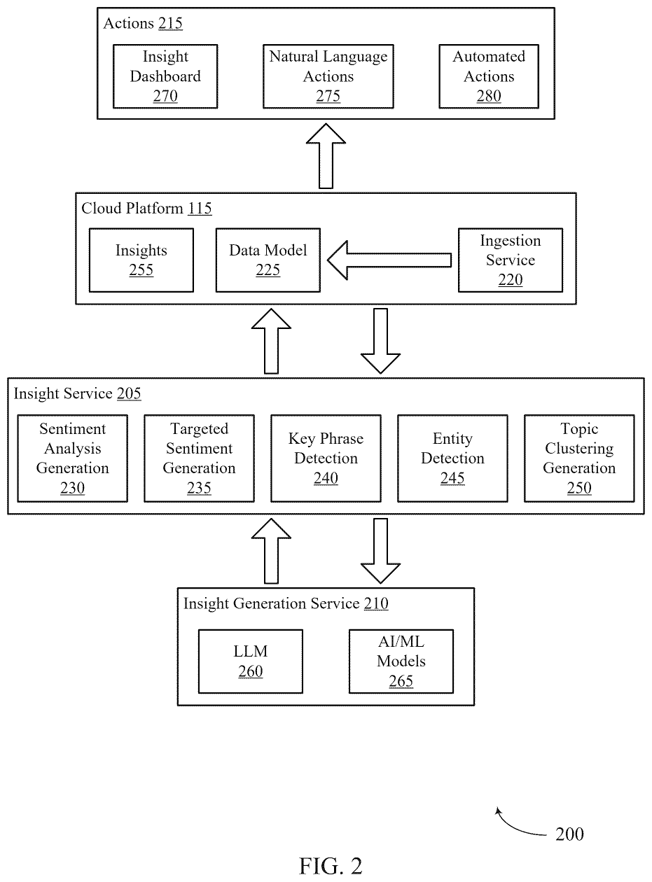

FIG. 2 shows an example of a system architecture 200 that supports multi-channel insight extraction and action generation in accordance with aspects of the present disclosure. In some examples, the system architecture 200 implements or may be implemented by the system 100. The system architecture 200 may illustrate a cloud platform 115 that can communicate with an insight service 205 and an insight generation service 210 to execute one or more actions 215, that may be implemented by devices or services described with reference to FIG. 1. Further, the system architecture 200 may illustrate the cloud platform 115 utilizing an ingestion service 220 to ingest data items that the insight service 205 and the insight generation service 210 can generate insights on for performing the one or more actions 215 in accordance with the techniques of the present disclosure to enable users to execute the one or more actions 215 in response to insights generated from data collected via different data channels.

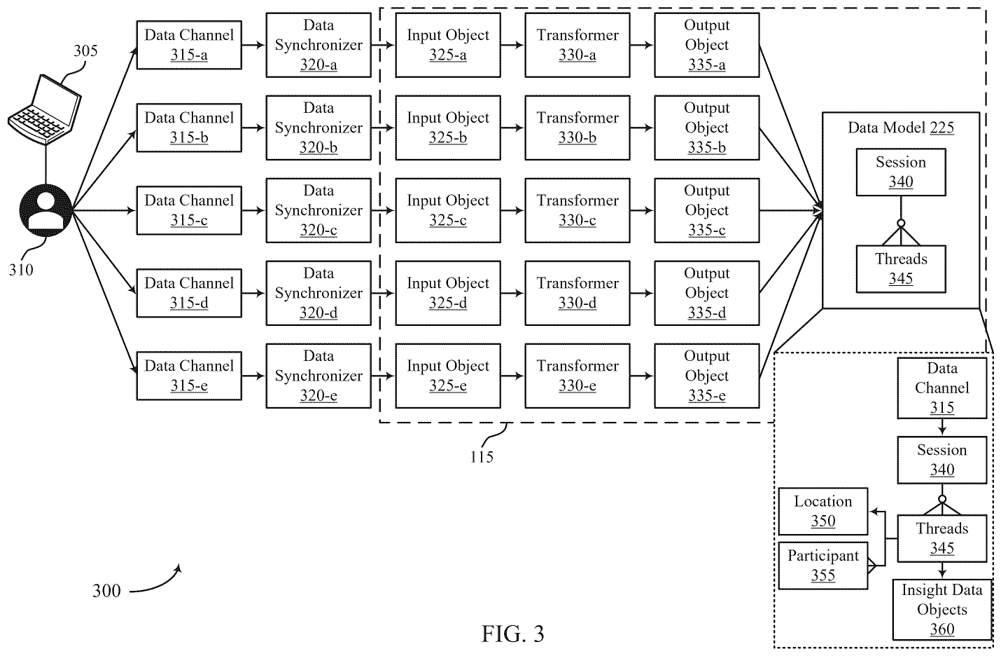

In some examples, the cloud platform 115 may use the ingestion service 220 to store channel-specific sessions and corresponding channel-specific threads within a data model 225. For example, the cloud platform 115 may ingest a set of data items from various different data channels that correspond to different channel-specific data structures via the ingestion service 220. In some cases, to store the channel-specific sessions and the corresponding channel-specific threads within the data model 225, the cloud platform may store the set of data items ingested via the ingestion service 220 in a first ephemeral data storage, transform the set of data items by converting each data item to be within a common data structure, and store the transformed data items within a second ephemeral data storage. In some examples, the first ephemeral data storage and the second ephemeral data storage may be hosted within the cloud platform 115, locally on a computing device (e.g., a cloud client 105 or a contact 110), or a combination thereof. Further description of the set of data items being stored within the first ephemeral data storage, transforming the set of data items, and storing the transformed set of data items within the second ephemeral data storage may be described elsewhere herein, such as with reference to FIG. 3.

To generate insights on the transformed data items, the system architecture 200 may include an insight service 205 that the data model 225 may communicate with to generate a set of insights on the set of transformed data items. In some cases, the insight service 205 may analyze the data collected from the various data channels via the ingestion service 220 to generate useful insights on the collected data. For example, the insight service 205 may include a sentiment analysis generation service 230, a targeted sentiment generation service 235, a key phrase detection service 240, an entity detection service 245, a topic clustering generation service 250, and the like. In some cases, the sentiment analysis generation service 230 and the targeted sentiment generation service 235 may be used to generate an understanding of the overall customer sentiment and specific emotions targeted at particular topics. Further, the insight service 205 may use the key phrase detection service 240 to identify relatively important phrases or keywords that frequently appear in customer interactions. Moreover, the insight service 205 may use the entity detection service 245 to identify and categorize entities such as product names, brands, or other relevant information mentioned in the feedback (e.g., the feedback indicated via a respective data item). Additionally, or alternatively, the insight service 205 may use the topic clustering generation service 250 to group similar feedback or comments into common topics or themes.

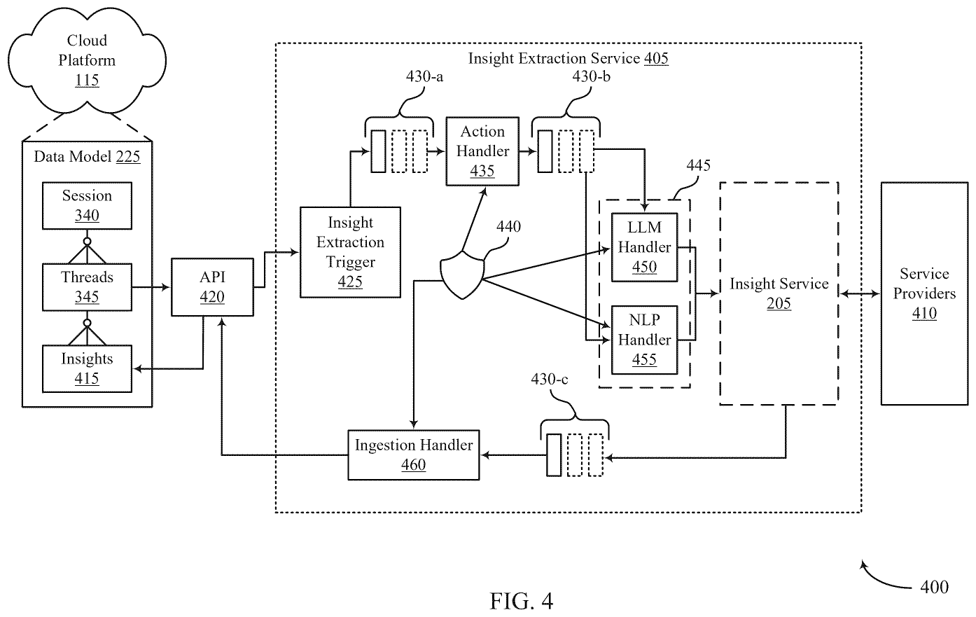

Utilizing the various services that the insight service 205 may support, the insight service 205 may communicate with the insight generation service 210 to generate insights 255 for the data items stored within the data model 225. In some cases, the insight generation service 210 may utilize an LLM 260 and AI/ML models 265 to generate the insights 255. In some examples, the AI/ML models 265 may include NLP models. For example, the insight generation service 210 may use the LLM 260 for the key phrase detection service 240 and the entity detection service 245 and the insight generation service 210 may use the ML models 265 for the sentiment analysis generation service 230, the targeted sentiment generation service 235, and the topic clustering generation service 250. In some cases, the LLM 260 may be a generic LLM 260 or a customized LLM 260. In some examples, the customized LLM 260 may be trained on customer data from multiple different customers to provide additional training data that is relatively more relevant. Additionally, or alternatively, when training the LLM 260 using customer data, the data may be anonymized such that data from a first customer is not exposed to a second customer when utilizing the LLM 260. Further, uses may utilize the LLM 260 and the AI/ML models 265 via one or more prompt templates or via custom prompts that are configured by the users. Further descriptions of the generation of the insights 255 via the insight service 205 and the insight generation service 210 may be described elsewhere herein, such as with reference to FIG. 4.

In some cases, the insight generation service 210 may also support deduplication functionalities. For example, multiple insights may be generated via the insight generation service 210 that are associated with a same topic or theme and the insight generation service 210 may cluster the multiple insights together into a group or “bucket” for the respective topic or theme. In some cases, the deduplication functionalities may assist with grouping and identifying similar insights 255 such that a user can perform actions on the insights 255 that are similar at the same time (e.g., concurrently or simultaneously). In some examples, the insight generation service may utilize the one or more AI/ML models 265 to perform the deduplication functions and to group similar insights 255.

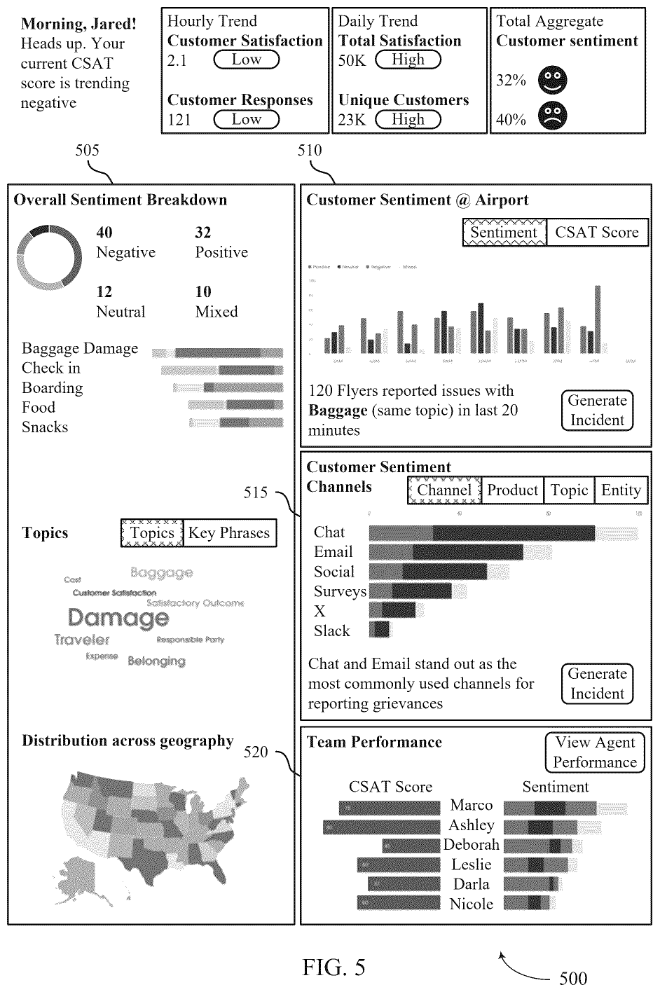

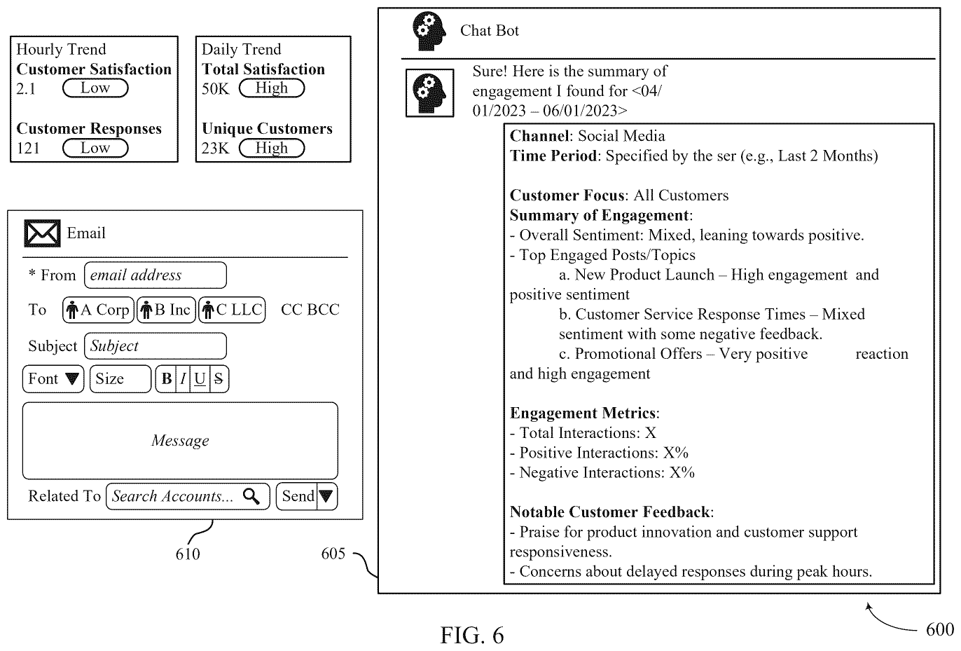

Further, in accordance with the techniques of the present disclosure, the insights 255 may be stored within the data model 225 and may be associated with respective channel-specific sessions and corresponding channel-specific threads stored within the insights 255. Moreover, based on the insights 255 being generated and stored within the data model 225, one or more actions 215 may be executed. In some examples, the one or more actions 215 may include generating an insight dashboard 270, executing one or more natural language actions 275, executing one or more automated actions 280, or any combination thereof. For example, based on the insight service 205 and the insight generation service 210 generating the insights 255, the insight dashboard 270 may be generated to display the insights 255. In another example, the one or more natural language actions 275 and the one or more automated actions 280 may be executed in response to the generation of the insights 255. Additionally, or alternatively, the one or more natural language actions 275 may be executed from the insight dashboard 270. Moreover, the one or more actions 215 may include executing AI-driven suggestions and automations based on the insights, providing AI agents with key insights to assist the agents in making more informed decisions, offering high-level insights or insight summaries to users, implementing actions to improve customer experiences, or any combination thereof. Further descriptions of the techniques of the present disclosure associated with the one or more actions 215 that may be executed in response to the generation of the insights 255 may be described elsewhere herein such as with reference to FIGS. 5 and 6.

FIG. 3 shows an example of a computing system 300 that supports multi-channel insight extraction and action generation in accordance with aspects of the present disclosure. In some examples, the computing system 300 implements or may be implemented by the system, the system architecture 200, or a combination thereof. Further, the computing system may include a computing device 305 operated by a user 310, that may be implemented by devices or services described with reference to FIG. 1. For example, the computing system 300 may receive data from the user 310 via a set of data channels 315 (e.g., a data channel 315-a, a data channel 315-b, a data channel 315-c, a data channel 315-d, and a data channel 315-e) that a cloud platform 115 can store within the data model 225.

In some examples, as illustrated elsewhere herein with reference to FIG. 2, the cloud platform 115 may ingest data from a user 310 or a set of users via a set of data channels 315. For example, a user 310 may interact with an organization via different data channels 315 such as via surveys, voice-based interactions or calls, chats, cases (e.g., customer support cases), social media, emails, or any combination thereof. As illustrated herein, each data channel 315 may collect user 310 data and transmit the data to a data synchronizer 320 (e.g., a data synchronizer 320-a, a data synchronizer 320-b, a data synchronizer 320-c, a data synchronizer 320-d, and a data synchronizer 320-e). Each respective data synchronizer 320 may ensure that the data from a respective data channel 315 is formatted, cleaned, and synchronized with the cloud platform 115. In some cases, the 115 may also be referred to as a data cloud or a cloud-based platform. Additionally, or alternatively, a data channel 315 may be a custom channel. The custom channel may enable a data channel 315 to ingest data from external data sources such that data stored in external data sources can be used in combination with data from internal data sources. In some cases, external data sources may be data sources such as social media, databases, or data centers 120 external from the computing system 200. For example, an organization may have feedback data from surveys, voice-based interactions, chats, cases, and emails stored within the computing system 200 and feedback data stored outside the computing system 200 that may be integrated and utilized via a customized data channel 315. In some cases, to utilize a customized data channel 315, a user may provide a mapping of one or more fields for the computing system 200. For example, to utilize social media sources, a user may map data associated with user names to a first field and data associated with message content to a second field such that the customized data channel 315 can ingest the data from a respective social media source.

The respective data synchronizers 320 may collect the data from the respective data channel 315 and map the data to a respective input object 325 (e.g., an input object 325-a, an input object 325-b, an input object 325-c, an input object 325-d, and an input object 325-e). In some cases, the respective input objects 325 may be input objects 325 of the cloud platform 115. Further, each data channel 315 may be associated with a respective input object 325. For example, the data channel 315-a may be associated with surveys and the input object 325-a may be associated with the data channel 315-a as a survey input object. Moreover, the cloud platform 115 may store the input objects 325 within a first ephemeral data storage.

After the data from the data channels 315 are mapped to respective input objects 325 and stored within the first ephemeral data storage, the cloud platform 115 may use a corresponding transformer 330 (e.g., a transformer 330-a, a transformer 330-b, a transformer 330-c, a transformer 330-d, and a transformer 330-e) to process the data of the input objects 325. In some examples, each data channel 315 may be associated with a respective transformer 330. For example, the transformer 330-a may be associated with the data channel 315-a. The data transformers 330 may perform various processing tasks on the data of the input objects 325 from the respective data channels such as data transformation. For example, each data channel 315 may be associated with a channel-specific data structure and the data within an input object 325 that is associated with a respective data channel 315 may also be associated with the channel-specific data structure of the respective data channel 315. Therefore, in accordance with the techniques of the present disclosure, the data transformers 330 may transform the data from a channel-specific data structure to a common data structure. For example, the transformer 330-a may transform the data from the input object 325-a from a first data structure into a common data structure and the transformer 330-b may transform the data from the input object 325-b from a second data structure that is different from the first data structure into a common data structure (e.g., a common normalized data structure).

In some examples, the transformers 330 may transform the data from respective data structures into the common data structure by mapping fields. For example, the transformer may extract data from a first field of the first data structure of the input object 325-a into a first field of the common data structure. Additionally, or alternatively, the transformers 330 may also extract portions of data from fields of input objects 325. For example, a field associated with a chat transcript may include a relatively large quantity of data (e.g., a relatively large quantity of chat message data items) and a transformer 330 may extract a subset of the data within the field (e.g., the first 10 messages out of 100 messages in a chat). In some cases, the subset of data may also be spread out from the set of data within a field or the transformers 330 may use one or more AI/ML models to generate summaries of the data to utilize.

The result or output from the transformers 330 may be stored within an output object 335 (e.g., an output object 335-a, an output object 335-b, an output object 335-c, an output object 335-d, and an output object 335-e) for each data channel 315. Thus, a data item from a respective data channel 315 that is transformed from an input object 325 associated with the respective data channel 315 via a transformer 330 may be stored within an output object 335 associated with the respective data channel 315. Moreover, the output objects 335 that include the transformed data items may be stored within a second ephemeral data storage. In some cases, for a customized data channel 315, a user may be provided with a normalized data structure of the output objects 335 and the user may establish a mapping of data from external data sources to the normalized data structure such that one or more output objects 335 can be generated using data from an external data source.

After storing the transformed data items within the output objects 335 in the second ephemeral data storage, the output objects 335 from each respective data channel 315 may be fed into the data model 225. The data model 225 may include channel-specific sessions 340 and one or more channel-specific threads 345 that correspond to the channel-specific sessions 340. In some examples, a respective channel-specific session 340 may refer to a grouping of related interactions or activities. Further, a respective channel-specific thread 345 may represent different conversational or activity threads within a session to allow the computing system 300 to track and understand the context of a conversation over multiple interactions.

For example, a channel-specific session 340 may be associated with a data channel 315 that corresponds to a group-based communication platform. A group-based communication platform may include one or more communication channels for communications between groups of users of a set of users associated with the group-based communication platform. For example, a first communication channel may be for communications with a first group of users of the set of users and a second communication channel may be for communications between a second group of users of the set of users that is different from the first group of users (e.g., the first group of users and the second group of users include at least one different user). In such case, a channel-specific session 340 that is associated with a data channel 315 corresponding to a group-based communication platform may be associated with a respective communication channel of the group-based communication platform. Thus, the one or more channel specific threads 345 corresponding to the channel-specific session 340 that is associated with a respective communication channel of the group-based communication platform may be associated with the individual communication messages within the respective communication channel. For example, a channel-specific thread 345 for the channel-specific session 340 may be an individual message within the respective communication channel that the channel-specific session 340 is associated with.

In some cases, each respective channel-specific threads 345 may be associated with a location 350 and a participant 355. In some examples, the location 350 of a respective channel-specific thread 345 may indicate the context of the respective channel-specific thread 345. In some cases, the location 350 may be associated with a geographic location. In some other cases, the location 350 may be a location within a group-based communication platform (e.g., a communication channel or a sub-communication channel of the group-based communication platform). Additionally, or alternatively, the location 350 may refer to a point in time. For example, the location 350 may indicate when a user sent or transmitted a respective message within a communication channel of the group-based communication platform. The participant 355 for a respective channel-specific thread 345 may indicate a user associated with the channel-specific thread 345. For example, the participant 355 may indicate a user associated with a message within a communication channel of the group-based communication platform that corresponds to a channel-specific thread. In another example, the channel-specific session 340 may be associated with a respective survey and the channel-specific threads 345 may be associated with various responses to the respective survey. Thus, the location 350 of a respective channel-specific thread 345 may be associated with a location of a user that completed the survey and the participant 355 of the respective channel-specific thread 345 may indicate the user of a respective survey response.

In some examples, to generate the channel-specific sessions 340 and channel-specific threads 345, the transformers 330 may be configured to transform the input objects 325 from respective data channels 315 into the output objects 335 that each have a common data structure. For example, for a data channel 315 associated with surveys, data from the surveys may be within a first data structure that includes one or more fields such as fields for question names, question responses, survey creation and completion times (e.g., dates and times), submitter identifiers, among others. In such examples, a respective transformer 330 associated with transforming data from a data channel 315 associated with surveys may be configured to map the data of the fields of the first data structure to fields of a common data structure. For example, the respective transformer 330 may combine (e.g., concatenate) the data from question name fields and question response fields to be included in a payload field of a channel-specific thread 345 that is in the common data structure. Further, the respective transformer 330 may take the data from a survey identifier field and map the data to a session identifier field for a respective channel-specific session 340. Additionally, or alternatively, the respective transformer 330 may map data from a submitter identifier field of the survey data structure that indicates a user that completed a survey to a participant identifier field in the common data structure to indicate a respective participant 355.

In another example, a data channel 315 may be associated with a chat between an agent and an end user and such data may be within a second data structure that is different from the first data structure. For example, the second data structure may include one or more different data fields such as message fields that indicate data of respective messages, conversation identifier fields, start and end time fields that indicate the start and end of interactions or conversations, among others. Thus, a respective transformer 330 configured for chat-based data channels 315 may map the one or more fields of the second data structure to the common data structure to generate channel-specific sessions 340 and channel-specific threads 345. For example, the respective transformer 330 may map data in a message field to a payload field of a channel-specific thread 345, data from a conversation identifier field to a session identifier field of a channel-specific session 340, data from a participant entity identifier field to a participant identifier field for a participant 355 of the channel-specific thread 345, or any combination thereof. Thus, the transformers 330 may be configured to transform data that is are in different data structures associated with respective data channels 315 into a common data structure such that the data model 255 is capable of generating the channel-specific sessions 340 and channel-specific threads 345 regardless of a data source of a respective data channel 315.

Therefore, in accordance with the techniques of present disclosure, the computing system 300 may store channel-specific sessions 340 and channel-specific threads 345 within the data model 225 to generate insight data objects 360 for the channel-specific threads 345 and the channel-specific sessions 340. Thus, the techniques of the present disclosure may enable the computing system 300 to execute actions automatically in response to the insights indicated via insight data objects 360. For example, as described elsewhere herein, such as with reference to FIG. 4, the techniques of the present disclosure may enable the data model 225 to communicate with one or more services to generate insights on channel-specific threads 345, channel-specific sessions 340, or both, for respective data channels 315.

Moreover, the data model 225 may be capable of communicating with the one or more services to generate the insights for the insight data objects 360 based on the data from the data channels 315 being transformed into a common data structure such that the data can be stored as channel-specific sessions 340 and channel-specific threads 345 within the data model 225. Further descriptions of the techniques of the present disclosure describing insights being generated on the transformed data items indicated via the channel-specific sessions 340 and the channel-specific threads 345 stored within the data model 225 may be described elsewhere herein, such as with reference to FIG. 4.

FIG. 4 shows an example of a computing system 400 that supports multi-channel insight extraction and action generation in accordance with aspects of the present disclosure. In some examples, the computing system 400 implements or may be implemented by the system, the system architecture 200, the computing system 300, or any combination thereof. Further, the computing system 400 may include cloud platform 115 that stores or hosts the data model 225, that may be implemented by devices or services described with reference to FIGS. 1 and 2. The data model 225 may include one or more channel-specific sessions 340 and one or more channel-specific threads 345 associated with the one or more channel-specific sessions 340 as described with reference to FIGS. 1 through 3. Further, the data model 225 may communicate with an insight extraction service 405 that may be associated with the insight service 205 and one or more service providers 410 associated with the insight generation service 210 to generate insights 415 on the channel-specific sessions 340, the channel-specific threads 345, or a combination thereof, as described with reference to FIGS. 1 through 3.

In some examples, to generate the insights 415 for the transformed data items stored within the data model 225 via the cloud platform 115 that are indicated via the channel-specific sessions 340 and the corresponding channel-specific threads 345, the data model 225 may communicate with the insight extraction service 405 via an API 420. In some examples, cloud platform 115 may be a centralized data storage and processing platform that stores (e.g., houses) raw data from the different data channels (e.g., the data channels 315 described with reference to FIG. 3) for insight extractions. Further, the data model 225 may store the overall interaction with users and systems. For example, the data model 225 may store channel-specific sessions 340 and corresponding channel-specific threads 345 (e.g., the channel-specific threads 345 may be indicative of conversations, chats, case comments, and the like) and track the insights 415 generated via the computing system 400. Moreover, as described elsewhere herein, such as with reference to FIG. 3, a channel-specific session 340 may represent a single instance of interaction (e.g., with a user or another system) and within a channel-specific session 340, a channel-specific thread 345 may represent individual conversations, tasks, or sub-topics. Further, the insights 415 may represent extracted insights or conclusions derived from the data stored within the data model 225.

In some examples, as illustrated herein, the API 420 may represent an interface between the cloud platform 115 and the insight extraction service 405. Further, the API 420 may process (e.g., handle) incoming requests and may transmit (e.g., route) the requests to the appropriate components. For example, in some cases, the data model 225 may transmit a request to the API 420 to generate the insights 415 on the transformed data items stored within the data model 225 via the channel-specific sessions 340 and the channel-specific threads 345. In some cases, the API 420 may transmit the request to the API 420 based on a threshold being satisfied. For example, the data model 225 may transmit the request to the API based on a quantity of channel-specific threads 345 that correspond to a channel-specific session 340 satisfying a threshold quantity of channel-specific threads 345. In some cases, the threshold may be determined, configured, or calculated based on a quantity of channel-specific threads 345 required to generate accurate and reliable insights 415 for a channel-specific session 340.

In response to receiving the request, the API 420 may transmit a message or indication to the insight extraction trigger 425. The insight extraction service 405 of the computing system 400 may utilize the insight extraction trigger 425 to process the extracting of the insights 415 from the data within the data model 225. In some cases, insight extraction trigger 425 may be invoked based on an additional record being ingested into a channel-specific threads data model object (e.g., an additional channel-specific thread 345 being added or ingested into the data model 225). Once the insight extraction trigger 425 is invoked, one or more channel-specific threads 345 may be added to a message queue 430 (e.g., a message queue 430-a). In some examples, the computing system 400 utilize respective message queue 430 (e.g., the message queue 430-a, a message queue 430-b, a message queue 430-c, or any combination thereof) to asynchronously store and manage tasks or data that has to be processed. Additionally, or alternatively, utilization of the message queues 430 may aid in improving and increasing the system performance and scalability of the computing system 400.

Further, after the channel-specific threads 345 are added to the message queue 430-a, an action handler 435 that triggers the process of extracting the insights 415 from the data within the channel-specific threads 345. In some examples, the action handler 435 may trigger the process for extracting the insights 415 from the data within each channel-specific thread 345 associated with a respective channel-specific session 340. For example, within the message queue 430-a, a first set of channel-specific threads 345 may be associated with a first channel-specific session 340 and a second set of channel-specific threads 345 may be associated with a second channel-specific session 340. Thus, in some cases, the action handler 435 may be triggered to initiate an extraction of the insights 415 for the first set of channel-specific threads 345 associated with the first channel-specific session 340, the second set of channel-specific threads 345 associated with the second channel-specific session 340, or both. In some examples, the action handler 435 may initiate the extraction of the insights 415 in accordance with a configuration stored within a configuration manager 440. The configuration manager 440 may manage a set of configuration settings for a service such as parameters related to insight 415 extraction, data processing, and system behavior.

After the action handler 435 is invoked or triggered, one or more channel-specific threads 345 may be added to the message queue 430-b to then be transmitted or forwarded to one or more ML model handlers 445. The one or more ML model handlers 445 may include an LLM handler 450 and a NLP handler 455. The data indicated via a respective channel-specific thread 345 may be transmitted from a respective ML model handler 445 to the insight service 205 that includes various different services for generating various different types of insights as described with reference to FIG. 2. In some cases, the data of a respective channel-specific thread 345 stored within the message queue 430-b may be transmitted to the LLM handler 450 or the NLP handler 455 based on a type of insight to be generated for the respective channel-specific thread 345. For example, a stored configuration within the configuration manager 440 may indicate a type of insight to generate for the respective channel-specific thread 345 and the ML model handler 445 that the data is forwarded to may be based on the type of insight. For example, if a stored configuration indicates that the insights 415 for a respective channel-specific thread 345 is associated with key phrase detection or topic extraction, the data associated with the respective channel-specific thread 345 may be sent to the LLM handler 450. In another example, if a stored configuration indicates that the insights 415 for a respective channel-specific thread 345 is associated with sentiment analysis or entity detection, the data associated with the respective channel-specific thread 345 may be sent to the NLP handler 455.

Further, the insight service 205 may communicate with one or more service providers 410 to generate the insights 415 in accordance with the respective ML handler 445, a configuration stored within the configuration manager 440, or both. In some examples, the one or more service providers may include an LLM or one or more AI/ML models used for NLP. In some cases, an AI/ML model used for NLP may be hosted locally on a device or may be hosted via a cloud-based platform (e.g., a cloud platform 115). Moreover, in some examples, the one or more service providers 410 may be associated with an LLM gateway which may connect the insight service 205 to an LLM service for NLP tasks, text generation, text comprehension, or any combination of thereof. Further, the one or more service providers 410 may also be associated with a gateway or interface to connect the insight service 205 with AI/ML models that can be used for extracting the insights 415 from the data indicated via channel-specific threads 345.

The generated output from the LLMs, AI/ML models, or both may then be transmitted from the one or more service providers 410 to the insight service 205 and added to the message queue 430-c before being transmitted to an ingestion handler 460. The ingestion handler 460 may handle the ingestion of data into the 115 and may validate the generated insight data, transform the data in a format acceptable to the cloud platform 115, and store the data within the cloud platform 115. For example, the ingestion handler 460 may transmit a request message to the API 420 to store the insights 415 within the data model 225 in response to the insights being generated via the insight service 205 and the one or more service providers 410.

Overall, in accordance with the techniques of the present disclosure, users may be capable of interacting with the computing system 400 via the data model 225 by initiating channel-specific sessions 340 and channel-specific threads 345. Once the channel-specific sessions 340 and channel-specific threads 345 are initiated, the related data may then be ingested into the cloud platform 115. Further, the insight extraction trigger 425 may accept insight extraction requests to initiate asynchronous extraction of the insights 415. Then, the action handler 435 may trigger the process of extracting the insights 415 from the data via an LLM gateway, a cloud-based platform hosting an AI/ML model, or both for tasks such as NLP. Moreover, the action handler 435 and the insight extraction service 405 may operate in accordance with configurations stored at the configuration manager 440 to ensure that the computing system 400 operates in accordance with the settings and parameters configured for respective users, groups of users, organizations, or any combination thereof. Then, the LLM handler 450 and the NLP handler 455 may be utilized to extract multiple insights 415 using the services associated with the respective ML model handler 445. Following, the techniques of the present disclosure may enable the ingestion handler 460 to ingest the insights 415 extracted from the data back into insight data objects 360 (e.g., data model objects) as described with reference to FIG. 3 within the data model 225. Once the insights 415 are stored within the data model 225, the techniques of the present disclosure may enable the data model 225, the cloud platform 115, or a combination thereof to automatically execute one or more actions based on the insights 415. Further descriptions of techniques of the present disclosure enabling the automatic execution of the one or more actions based on the insights 415 may be described elsewhere herein, such as with reference to FIGS. 5 and 6.

FIG. 5 shows an example of a user interface 500 that supports multi-channel insight extraction and action generation in accordance with aspects of the present disclosure. In some examples, the user interface 500 implements or may be implemented by the system, the system architecture 200, the computing system 300, the computing system 400, or any combination thereof. Further, in some cases, the user interface 500 may be referred to as a dashboard elsewhere herein, such as an insight dashboard 270 described with reference to FIG. 2. Moreover, the user interface 500 may be displayed to one or more users via a computing device, such as a cloud client 105, a contact 110, a computing device 305, or any combination thereof, described with reference to FIGS. 1 and 3.

In some examples, in response to one or more insights being generated for respective channel-specific sessions and corresponding channel-specific threads, the cloud platform 115 that is associated with a data model that stores the respective channel-specific sessions and corresponding channel-specific threads may execute one or more actions. In some cases, as described elsewhere herein with reference to FIG. 2, the one or more actions may include a generation of a dashboard to provide users with a visualization of the generated insights. In some examples, the user interface 500 may be an example of a dashboard that includes one or more user interface elements (e.g., a user interface element 505, a user interface element 510, a user interface element 515, a user interface element 520, or any combination thereof).

Within the user interface 500, a computing system (e.g., the system 100, the computing system 300, the computing system 400, or any combination thereof) may display the insights derived from the data within a data model (e.g., the data model 225 described with reference to FIG. 2) that is associated with a cloud platform 115 for ease of consumption by a user. In some examples, the one or more user interface elements may be used to display insights such as sentiments across channels, topics, geographic regions, entities, key phrases, and the like. For example, the user interface element 505 may include a first portion that displays a graphical representation of an overall sentiment, a second portion that displays a graphical representation of frequent topics and key phrases, and a third portion that displays a graphical representation of the sentiment distributed across geography (e.g., geography of a town or city, county, state, territory, region, country, a set of countries, a continent, the world, and the like). Further, the user interface element 510 may display another graphical representation to illustrate a respective sentiment insight or a respective customer service satisfaction (CSAT) score insight. Moreover, the user interface element 515 may display a graphical representation of the overall sentiment of various channels (e.g., communication channels), products, topics, entities, or any combination thereof, across various data channels. For example, the user interface element 515 may illustrate the different in sentiment for a respective product in a first data channel associated with user surveys and a second data channel associated with a group-based communication platform. Additionally, or alternatively, the user interface element 520 may illustrate a graphical representation of a team performance. For example, the user interface element 520 may display the CSAT score and sentiment associated with various users that are members of a group of users or team of an organization.

In some examples, the graphical representations may be charts and graphs such as pie charts, bar graphs, word clouds, and the like. However, it should be understood by someone having ordinary skill in the art that the types of charts and graphs illustrated via the user interface 500 may be examples and any other type of chart, graph, or visual representation that can display a generated insight may be used within the user interface 500. In some examples, the user interface 500 may be an example of a dashboard for a respective user that displays overall CSAT and sentiment analysis scores for the respective user. Further, in some cases, the first portion of the user interface element 505 may include a pie chart or donut chart that displays an overall sentiment breakdown between various different topics for the respective user, the second portion of the user interface element 505 may display a word cloud that displays a frequency of specific topics and a frequency of key phrases within customer feedback and interaction data, and the third portion of the user interface element 505 may display a map of a country that displays a sentiment analysis insight disturbed across the geography of the respective country. Further, the user interface element 510 may display a bar graph (e.g., a vertical bar graph) that shows the customer sentiment or the CSAT score of the respective user at a respective location (e.g., a respective airport as illustrated herein) across time. Moreover, the user interface element 515 may display another bar graph (e.g., a horizontal bar graph) to illustrate the customer sentiment within respective data channels for communication channels, products, topics, and entities, across the respective data channels. Additionally, or alternatively, the user interface element 520 may display another bar graph (e.g., a horizontal bar graph) that displays the CSAT score and the overall sentiment for respective team members for the respective user to see how they compare to other users on their team.

In some examples, the one or more user interface elements may include one or more interactive elements. For example, the second portion of the user interface element 505 may include a interactive element for a respective user to switch from a display of a word cloud illustrating a frequency of topics to a display of a word cloud illustrating a frequency of key phrases. In another example, the user interface element 510 and the user interface element 515 may also include interactive elements associated with switching the display of the graphical representation of the respective user interface element. Additionally, or alternatively, the user interface element 510 and the user interface element 515 may have additional interactive elements that can be selected to trigger additional actions. For example, the user interface element 510 and the user interface element 515 may have interactive elements to generate an incident. In some cases, when the additional interactive elements are selected, another user interface may be displayed over the user interface 500 to allow the respective user to select an action to be performed. In some other cases, a selection of the additional interactive elements may automatically trigger an action to be executed.

Additionally, or alternatively, an action may be executed based on a threshold being satisfied. For example, if the sentiment analysis satisfies a threshold within a threshold amount of time (e.g., the sentiment analysis level is above a threshold level for over 30 minutes), an action may be automatically executed. In another example, the threshold may be such that if a sentiment analysis satisfies a sentiment threshold within a threshold quantity of data channels an action may automatically be executed. In some examples, an automatic action may include a transmission of an electronic message. Moreover, in some examples, one or more actions such as generating a summary of the set of insights, generating an electronic message associated with the set of insights, and the like, may be executed automatically in response to the generation of the set of insights. For example, if the set of insights are generated and the set of insights satisfy a threshold, one or more actions may be executed automatically based on settings within a configuration for a respective user or organization. Further descriptions of techniques of the present disclosure enabling a system to automatically execute one or more actions in response to an insight may be described elsewhere herein, such as with reference to FIG. 6.

FIG. 6 shows an example of a user interface 600 that supports multi-channel insight extraction and action generation in accordance with aspects of the present disclosure. In some examples, the user interface 600 implements or may be implemented by the system, the system architecture 200, the computing system 300, the computing system 400, the user interface 500, or any combination thereof. Further, in some cases, the user interface 600 may be referred to as a dashboard elsewhere herein, such as an insight dashboard 270 described with reference to FIG. 2. Moreover, the user interface 600 may be displayed to one or more users via a computing device, such as a cloud client 105, a contact 110, a computing device 305, or any combination thereof, described with reference to FIGS. 1 and 3.

In some examples, as described with reference to FIG. 5, the user interface 600 may illustrate a dashboard that is capable of displaying insights generated based on customer feedback and interaction data. In some cases, the user interface 600 may display a chat bot display 605 that displays a user interface for communicating with an AI tool. In some examples, the AI tool may be a generative AI tool as described with reference to FIG. 1. For example, a user may be capable of transmitting one or more queries or requests to the AI tool based on a set of generated insights. In some cases, the generative AI tool associated with the chat bot display 605 may be capable of generating human-like test responses in real-time conversations. Further, in some examples, the generative AI tool may be capable of learning and improving the output or responses to requests over time based on past interactions.

In some cases, a user may transmit a request or query to the chat bot display 605 to generate a summary of a respective customer. For example, a user may be able to see that the insights generated for the respective customer seem different than expected and thus may request for a generation of a summary of the set of insights. In some other cases, a user may request for a topic summary. For example, the user may transit a request via the chat bot display 605 for the generative AI tool to generate a summary of negative topics within the last 24 hours. In response, the generative AI tool may generate the summaries, or the generative AI tool may transmit a message via the chat bot display 605 to request the user to select one or more topics from a list of negative topics within the last 24 hours. In such cases, the generative AI tool may automatically generate and display the respective response within the chat bot display 605 for the user.

In some examples, the user may also request for a summary of engagement within the chat bot display 605. Further, after displaying the engagement summary within the chat bot display 605 the generative AI tool may provide the user with one or more options such as copying the response (e.g., the engagement summary), forwarding the response, or adding the response to a customer profile. In some cases, the generative AI tool may also generate an electronic message for a user to transmit and display the generated electronic message within a user interface element 610. The user interface element 610 may display an electronic message to be transmitted to one or more users. In some cases, the user may be capable of editing or adjusting the language, formatting, attachments, users the electronic message is being sent to, or any combination thereof within the user interface element 610. Additionally, or alternatively, the user may request, via the chat bot display 605, for the generative AI tool to generate the electronic message. Further, in some examples, a respective user may be capable of selection one or more user interface elements of the user interface 600 to trigger a request to the generative AI tool via the chat bot display 605 or to trigger the generative AI tool to automatically perform one or more actions. For example, a respective user may select a graphical representation of an insight displayed within the user interface 600 and based on the selection the user may be capable of querying the generative AI tool to perform one or more actions such a generating a summary of the selected insight, generating an electronic message within the user interface element 610 based on the selected insight, and the like.

In some other examples, a user may utilize the user interface 600 to perform one or more actions via the generated insights. In some cases, the one or more actions may include generating an email via the user interface 610. In another case, the one or more actions may include starting a screen flow for a set of actions that a user wants to create from the screen. In some examples, the set of actions may include creating a case such that a user can generate a case for one or more respective insights via the user interface 600. In another example, the set of actions may include generation of an incident based on one or more respective insights via the user interface 600. For example, a user may select an interactive element of the user interface 600 to create a case or incident which may open or display another user interface that prompts the user to complete a case record or incident record.

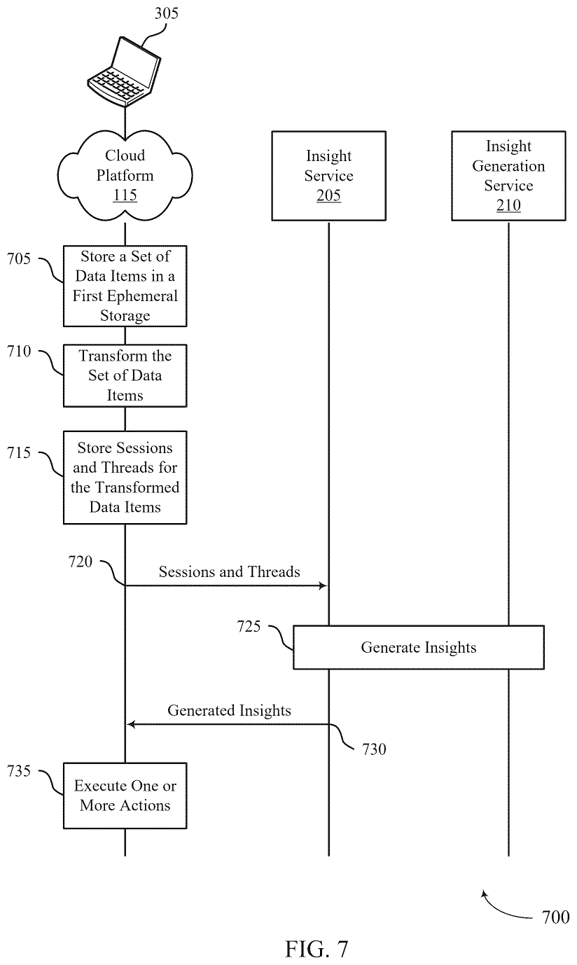

Thus, the user may be capable of using the user interface 600, the chat bot display 605, the user interface element 610, or any combination thereof to execute actions in response to insights in accordance with the techniques of the present disclosure. Further descriptions of the techniques of the present disclosure may be described elsewhere herein, such as with reference to FIG. 7.

FIG. 7 shows an example of a process flow 700 that supports multi-channel insight extraction and action generation in accordance with aspects of the present disclosure. In some examples, the process flow 700 may implement or may be implemented by the system 100, the system architecture 200, the computing system 300, the computing system 400, the user interface 500, the user interface 600, or any combination thereof. The process flow 700 may include the computing device 305, the cloud platform 115, the insight service 205, and the insight generation service 210, which may be examples of devices or services described elsewhere herein including with reference to FIGS. 1 through 7. Further, one or more users may operate the computing device 305 as described elsewhere herein with reference to FIGS. 1 and 2.

In the following description of the process flow 700, the operations may be performed by the computing device 305, the cloud platform 115, the insight service 205, and the insight generation service 210 in different orders or at different times. Some operations may also be left out of the process flow 700, or other operations may be added. Although the process flow 700 may be described as being performed by the computing device 305, the cloud platform 115, the insight service 205, and the insight generation service 210, some aspects of some operations may also be performed by other devices, services, or models described elsewhere herein including with reference to FIGS. 1 through 7.

At 705, the cloud platform 115 may ingest a set of data items ingested from a set of data channels via a computing device 305 and store the set of data items in a first ephemeral data storage. The data items from each data channel of the set of data channels may correspond to a channel-specific data structure. In some examples, the cloud platform 115 may obtain a respective data item from a respective data channel directly from a user or indirectly from the user via the respective data channel. In some other examples, the cloud platform 115 may map the set of data items from the set of data channels to a first set of channel-specific data objects. In such cases, the cloud platform 115 may storing the set of data items in the first ephemeral data storage may include storing the first set of channel-specific data objects.

At 710, the cloud platform 115 may transform the set of data items from a respective channel-specific data structure into a common data structure to obtain a set of transformed data items that are stored in a second ephemeral data storage. In some cases, the cloud platform 115 may transform the first set of channel-specific data objects into a second set of channel-specific data objects, where the second set of channel-specific data objects includes the set of data items within the common data structure. In some other cases, the cloud platform 115 may transform the set of data items into the common data structure to obtain the set of transformed data items via a set of channel-specific transformers.

At 715, the cloud platform 115 may, for each transformed data item of the set of transformed data items store a channel-specific session and one or more channel-specific threads corresponding to the channel-specific session in a first data model that is associated with cloud platform 115. A respective channel-specific session may correspond to metadata representing a grouping of channel-specific threads. Further, at 720, the cloud platform 115 may transmit, for each transformed data item from the first data model associated with the cloud platform 115 to the insight service 205, the channel-specific session and the one or more channel-specific threads corresponding to the channel-specific session may be transmitted.

At 725, the insight service 205 in conjunction with the insight generation service 210 may generate a set of insights on the set of transformed data items stored within the first data model in accordance with a stored configuration and via one or more machine learning models of a set of machine learning models. A respective insight may be associated with the channel-specific session and the one or more channel-specific threads of a respective transformed data item. In some examples, prior to generating the insights, the cloud platform 115 may receive a first configuration that includes instructions for the generation of the set of insights via one or more machine learning models of a set of machine learning models, such that the stored configuration includes the first configuration. In some cases, the cloud platform 115 may transmit the first configuration to the insight service 205, the insight generation service 210, or both.

In some cases, the first data model associated with the cloud platform 115 may transmit, to the insight service 205, an API request message to trigger an insight extraction service (e.g., the insight service 205 and the insight generation service 210) to generate the set of insights. In such cases, the set of insights may be stored within the first data model based on the API request message. In some examples, to generate the set of insights, the set of transformed data items associated with respective channel-specific sessions and respective one or more channel-specific threads of respective transformed data items may be stored within a first message queue. Further, the set of transformed data items may be stored within a second message queue, where the second message queue is associated with the one or more machine learning models of the set of machine learning models configured for generation of the set of insights. Moreover, the set of insights on the set of transformed data items may be obtained from the one or more machine learning models of the set of machine learning models, and the set of insights may be stored in the first data model based on obtaining the set of insights. Additionally, or alternatively, a respective machine learning model used for the generation of a respective insight of the set of insights on a respective transformed data item of the set of transformed data items may be based on with a type of insight being generated for the respective transformed data item.

At 730, the set of insights may be transmitted from the insight service 205 to the first data model, such that the set of insights are stored within the first data model associated with the cloud platform 115. Further, at 735, the cloud platform 115 may execute one or more actions based on generation of the set of insights on the set of transformed data items. In some examples, the one or more actions may include the cloud platform 115 displaying, via a first user interface of a computing device 305, the set of insights on the set of transformed data items, where the first user interface includes one or more interactive elements that are associated with respective insights of the set of insights. In some other examples, the cloud platform 115 may receive, from a first user, a request for an insight on a respective set of data, and the cloud platform 115 may automatically execute the one or more actions based on receiving of the request. Additionally, or alternatively, the cloud platform 115 may automatically generate a summary of the set of insights, an electronic message associated with the set of insights, or both in response to the generation of the set of insights. Further, in some cases, the cloud platform 115 may execute the one or more actions based on one or more insights of the set of insights satisfying a threshold associated with the one or more insights. In such cases, the summary of the set of insights, the electronic message, or both may be generated based on the one or more insights satisfying the threshold.

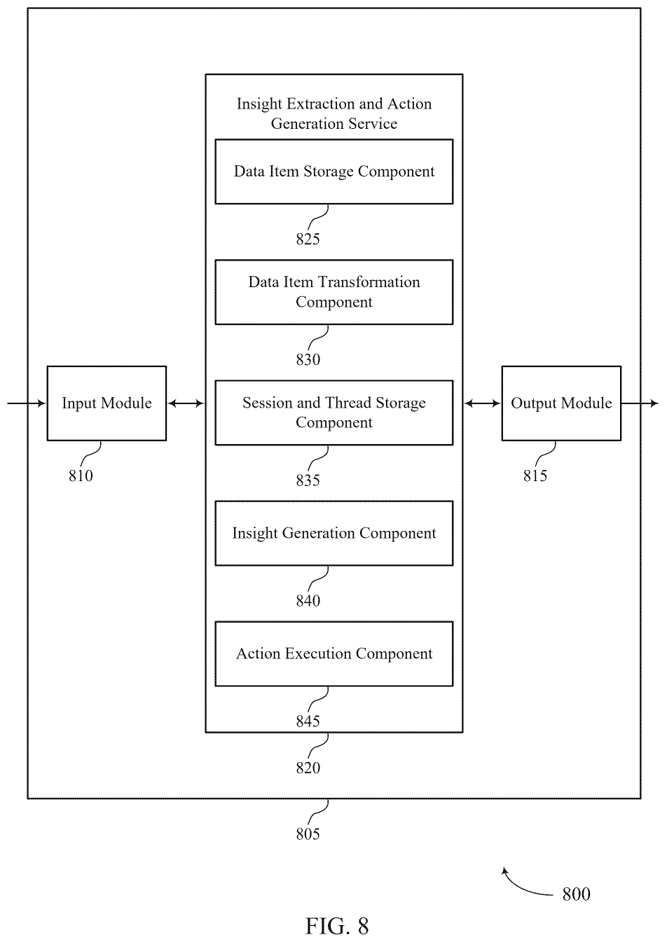

FIG. 8 shows a block diagram 800 of a device 805 that supports multi-channel insight extraction and action generation in accordance with aspects of the present disclosure. The device 805 may include an input module 810, an output module 815, and an insight extraction and action generation service 820. The device 805, or one or more components of the device 805 (e.g., the input module 810, the output module 815, the insight extraction and action generation service 820), may include at least one processor, which may be coupled with at least one memory, to support the described techniques. Each of these components may be in communication with one another (e.g., via one or more buses).

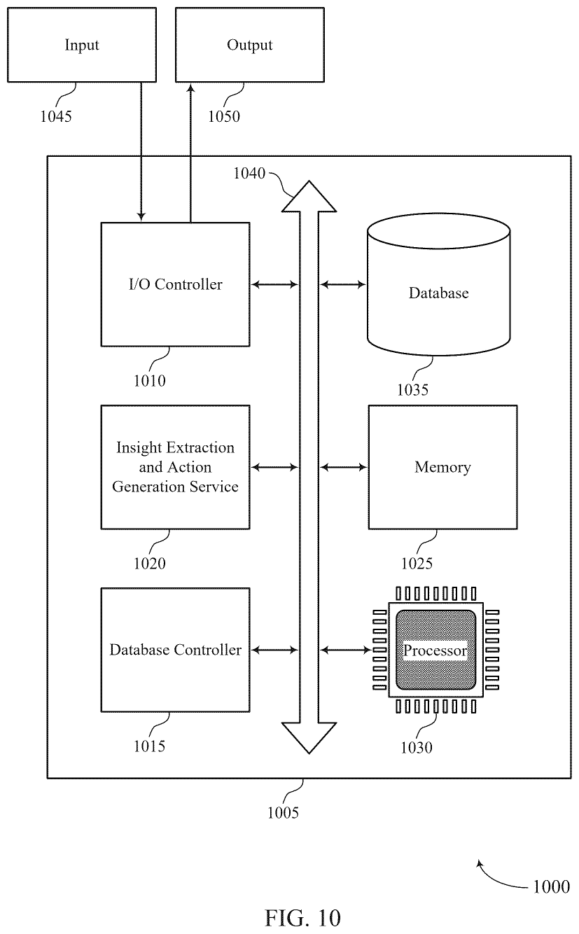

The input module 810 may manage input signals for the device 805. For example, the input module 810 may identify input signals based on an interaction with a modem, a keyboard, a mouse, a touchscreen, or a similar device. These input signals may be associated with user input or processing at other components or devices. In some cases, the input module 810 may utilize an operating system such as iOS®, ANDROID®, MS-DOS®, MS-WINDOWS®, OS/2®, UNIX®, LINUX®, or another known operating system to handle input signals. The input module 810 may send aspects of these input signals to other components of the device 805 for processing. For example, the input module 810 may transmit input signals to the insight extraction and action generation service 820 to support multi-channel insight extraction and action generation. In some cases, the input module 810 may be a component of an input/output (I/O) controller 1010 as described with reference to FIG. 10.

The output module 815 may manage output signals for the device 805. For example, the output module 815 may receive signals from other components of the device 805, such as the insight extraction and action generation service 820, and may transmit these signals to other components or devices. In some examples, the output module 815 may transmit output signals for display in a user interface, for storage in a database or data store, for further processing at a server or server cluster, or for any other processes at any number of devices or systems. In some cases, the output module 815 may be a component of an I/O controller 1010 as described with reference to FIG. 10.

For example, the insight extraction and action generation service 820 may include a data item storage component 825, a data item transformation component 830, a session and thread storage component 835, an insight generation component 840, an action execution component 845, or any combination thereof. In some examples, the insight extraction and action generation service 820, or various components thereof, may be configured to perform various operations (e.g., receiving, monitoring, transmitting) using or otherwise in cooperation with the input module 810, the output module 815, or both. For example, the insight extraction and action generation service 820 may receive information from the input module 810, send information to the output module 815, or be integrated in combination with the input module 810, the output module 815, or both to receive information, transmit information, or perform various other operations as described herein.

The insight extraction and action generation service 820 may support data processing in accordance with examples as disclosed herein. The data item storage component 825 may be configured to support storing, in a first ephemeral data storage, a set of multiple data items ingested from a set of multiple data channels, where data items from each data channel of the set of multiple data channels correspond to a channel-specific data structure. The data item transformation component 830 may be configured to support transforming the set of multiple data items from a respective channel-specific data structure into a common data structure to obtain a set of multiple transformed data items that are stored in a second ephemeral data storage. The session and thread storage component 835 may be configured to support storing, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads. The insight generation component 840 may be configured to support generating, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model. The action execution component 845 may be configured to support executing one or more actions based on generation of the set of multiple insights on the set of multiple transformed data items.

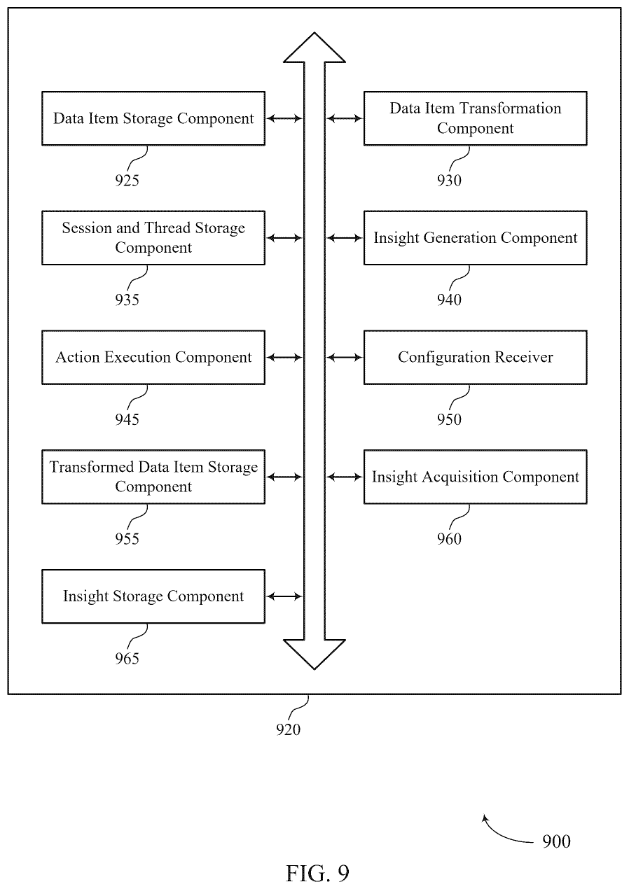

FIG. 9 shows a block diagram 900 of an insight extraction and action generation service 920 that supports multi-channel insight extraction and action generation in accordance with aspects of the present disclosure. The insight extraction and action generation service 920 may be an example of aspects of an insight extraction and action generation service or an insight extraction and action generation service 820, or both, as described herein. The insight extraction and action generation service 920, or various components thereof, may be an example of means for performing various aspects of multi-channel insight extraction and action generation as described herein. For example, the insight extraction and action generation service 920 may include a data item storage component 925, a data item transformation component 930, a session and thread storage component 935, an insight generation component 940, an action execution component 945, a configuration receiver 950, a transformed data item storage component 955, an insight acquisition component 960, an insight storage component 965, or any combination thereof. Each of these components, or components of subcomponents thereof (e.g., one or more processors, one or more memories), may communicate, directly or indirectly, with one another (e.g., via one or more buses).

The insight extraction and action generation service 920 may support data processing in accordance with examples as disclosed herein. The data item storage component 925 may be configured to support storing, in a first ephemeral data storage, a set of multiple data items ingested from a set of multiple data channels, where data items from each data channel of the set of multiple data channels correspond to a channel-specific data structure. The data item transformation component 930 may be configured to support transforming the set of multiple data items from a respective channel-specific data structure into a common data structure to obtain a set of multiple transformed data items that are stored in a second ephemeral data storage. The session and thread storage component 935 may be configured to support storing, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads. The insight generation component 940 may be configured to support generating, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model. The action execution component 945 may be configured to support executing one or more actions based on generation of the set of multiple insights on the set of multiple transformed data items.

In some examples, the data item storage component 925 may be configured to support obtaining, from a user, a respective data item from a respective data channel, the respective data item being obtained directly from the user or indirectly from the user via the respective data channel, where the set of multiple data items are stored within the first ephemeral data storage based at least in part obtaining the respective data item.

In some examples, the data item storage component 925 may be configured to support mapping the set of multiple data items from the set of multiple data channels to a first set of multiple channel-specific data objects, where storing the set of multiple data items in the first ephemeral data storage includes storing the first set of multiple channel-specific data objects.

In some examples, to support transforming the set of multiple data items, the data item transformation component 930 may be configured to support transforming the first set of multiple channel-specific data objects into a second set of multiple channel-specific data objects, the second set of multiple channel-specific data objects including the set of multiple data items within the common data structure.

In some examples, the configuration receiver 950 may be configured to support receiving a first configuration that includes instructions for the generation of the set of multiple insights via the one or more machine learning models of the set of multiple machine learning models, where the stored configuration includes the first configuration.

In some examples, to support transforming the set of multiple data items, the data item transformation component 930 may be configured to support transforming, via a set of multiple channel-specific transformers, the set of multiple data items into the common data structure to obtain the set of multiple transformed data items.

In some examples, to support generating the set of multiple insights, the insight generation component 940 may be configured to support receiving, from the first data model, an application programming interface (API) request message to trigger an insight extraction service to generate the set of multiple insights, where the set of multiple insights are stored within the first data model based on the API request message.

In some examples, to support generating the set of multiple insights, the transformed data item storage component 955 may be configured to support storing, within a first message queue, the set of multiple transformed data items associated with respective channel-specific sessions and respective one or more channel-specific threads of respective transformed data items. In some examples, to support generating the set of multiple insights, the transformed data item storage component 955 may be configured to support storing, within a second message queue, the set of multiple transformed data items, the second message queue being associated with the one or more machine learning models of the set of multiple machine learning models configured for generation of the set of multiple insights. In some examples, to support generating the set of multiple insights, the insight acquisition component 960 may be configured to support obtaining, from the one or more machine learning models of the set of multiple machine learning models, the set of multiple insights on the set of multiple transformed data items. In some examples, to support generating the set of multiple insights, the insight storage component 965 may be configured to support storing, in the first data model, the set of multiple insights based on obtaining the set of multiple insights.

In some examples, to support executing the one or more actions, the action execution component 945 may be configured to support displaying, via a first user interface, the set of multiple insights on the set of multiple transformed data items, the first user interface including one or more interactive elements that are associated with respective insights of the set of multiple insights.

In some examples, to support executing the one or more actions, the action execution component 945 may be configured to support receiving, from a first user, a request for an insight on a respective set of data, where the one or more actions are executed automatically based on reception of the request.

In some examples, to support executing the one or more actions, the action execution component 945 may be configured to support generating, automatically in response to the generation of the set of multiple insights, a summary of the set of multiple insights, an electronic message associated with the set of multiple insights, or both.

In some examples, to support executing the one or more actions, the action execution component 945 may be configured to support executing the one or more actions based on one or more insights of the set of multiple insights satisfying a threshold associated with the one or more insights, where the summary of the set of multiple insights, the electronic message, or both are generated based on the one or more insights satisfying the threshold.

In some examples, the set of multiple machine learning models includes a large language model (LLM), a natural language processing (NLP) model, or both.

In some examples, the set of multiple insights are associated with sentiment analysis, target sentiments, key phrases, entity detection, topic clustering, or any combination thereof.

In some examples, a respective machine learning model used for the generation of a respective insight of the set of multiple insights on a respective transformed data item of the set of multiple transformed data items is based on with a type of insight being generated for the respective transformed data item.

FIG. 10 shows a diagram of a system 1000 including a device 1005 that supports multi-channel insight extraction and action generation in accordance with aspects of the present disclosure. The device 1005 may be an example of or include components of a device 805 as described herein. The device 1005 may include components for bi-directional data communications including components for transmitting and receiving communications, such as an insight extraction and action generation service 1020, an I/O controller, such as an I/O controller 1010, a database controller 1015, at least one memory 1025, at least one processor 1030, and a database 1035. These components may be in electronic communication or otherwise coupled (e.g., operatively, communicatively, functionally, electronically, electrically) via one or more buses (e.g., a bus 1040).

The I/O controller 1010 may manage input signals 1045 and output signals 1050 for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. In other cases, the I/O controller 1010 may represent or interact with a modem, a keyboard, a mouse, a touchscreen, or a similar device. In some cases, the I/O controller 1010 may be implemented as part of a processor 1030. In some examples, a user may interact with the device 1005 via the I/O controller 1010 or via hardware components controlled by the I/O controller 1010.

The database controller 1015 may manage data storage and processing in a database 1035. In some cases, a user may interact with the database controller 1015. In other cases, the database controller 1015 may operate automatically without user interaction. The database 1035 may be an example of a single database, a distributed database, multiple distributed databases, a data store, a data lake, or an emergency backup database.

Memory 1025 may include random-access memory (RAM) and read-only memory (ROM). The memory 1025 may store computer-readable, computer-executable software including instructions that, when executed, cause at least one processor 1030 to perform various functions described herein. In some cases, the memory 1025 may contain, among other things, a basic I/O system (BIOS) which may control basic hardware or software operation such as the interaction with peripheral components or devices. The memory 1025 may be an example of a single memory or multiple memories. For example, the device 1005 may include one or more memories 1025.

The processor 1030 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 1030 may be configured to operate a memory array using a memory controller. In other cases, a memory controller may be integrated into the processor 1030. The processor 1030 may be configured to execute computer-readable instructions stored in at least one memory 1025 to perform various functions (e.g., functions or tasks supporting multi-channel insight extraction and action generation). The processor 1030 may be an example of a single processor or multiple processors. For example, the device 1005 may include one or more processors 1030.

The insight extraction and action generation service 1020 may support data processing in accordance with examples as disclosed herein. For example, the insight extraction and action generation service 1020 may be configured to support storing, in a first ephemeral data storage, a set of multiple data items ingested from a set of multiple data channels, where data items from each data channel of the set of multiple data channels correspond to a channel-specific data structure. The insight extraction and action generation service 1020 may be configured to support transforming the set of multiple data items from a respective channel-specific data structure into a common data structure to obtain a set of multiple transformed data items that are stored in a second ephemeral data storage. The insight extraction and action generation service 1020 may be configured to support storing, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads. The insight extraction and action generation service 1020 may be configured to support generating, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model. The insight extraction and action generation service 1020 may be configured to support executing one or more actions based on generation of the set of multiple insights on the set of multiple transformed data items.

By including or configuring the insight extraction and action generation service 1020 in accordance with examples as described herein, the device 1005 may support techniques for storing customer feedback and interaction data from various different data channels and executing actions in response to generated insights on the data to support an increase in accuracy and reliability in insight generation and to reduce latency associated with executing actions in response to insights.

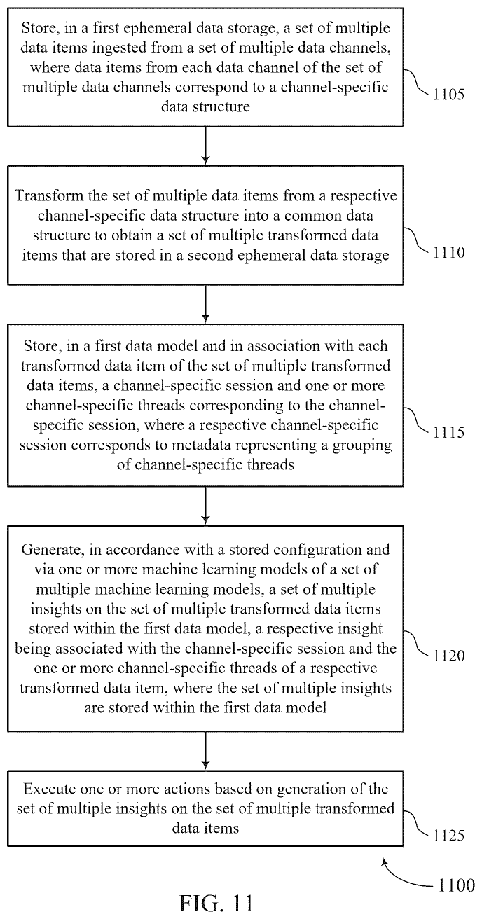

FIG. 11 shows a flowchart illustrating a method 1100 that supports multi-channel insight extraction and action generation in accordance with aspects of the present disclosure. The operations of the method 1100 may be implemented by a computing device or its components as described herein. For example, the operations of the method 1100 may be performed by a computing device as described with reference to FIGS. 1 through 10. In some examples, a computing device may execute a set of instructions to control the functional elements of the computing device to perform the described functions. Additionally, or alternatively, the computing device may perform aspects of the described functions using special-purpose hardware.

At 1105, the method may include storing, in a first ephemeral data storage, a set of multiple data items ingested from a set of multiple data channels, where data items from each data channel of the set of multiple data channels correspond to a channel-specific data structure. The operations of 1105 may be performed in accordance with examples as disclosed herein. In some examples, aspects of the operations of 1105 may be performed by a data item storage component 925 as described with reference to FIG. 9.

At 1110, the method may include transforming the set of multiple data items from a respective channel-specific data structure into a common data structure to obtain a set of multiple transformed data items that are stored in a second ephemeral data storage. The operations of 1110 may be performed in accordance with examples as disclosed herein. In some examples, aspects of the operations of 1110 may be performed by a data item transformation component 930 as described with reference to FIG. 9.

At 1115, the method may include storing, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads. The operations of 1115 may be performed in accordance with examples as disclosed herein. In some examples, aspects of the operations of 1115 may be performed by a session and thread storage component 935 as described with reference to FIG. 9.

At 1120, the method may include generating, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model. The operations of 1120 may be performed in accordance with examples as disclosed herein. In some examples, aspects of the operations of 1120 may be performed by an insight generation component 940 as described with reference to FIG. 9.

At 1125, the method may include executing one or more actions based on generation of the set of multiple insights on the set of multiple transformed data items. The operations of 1125 may be performed in accordance with examples as disclosed herein. In some examples, aspects of the operations of 1125 may be performed by an action execution component 945 as described with reference to FIG. 9.

A method for data processing by an apparatus is described. The method may include storing, in a first ephemeral data storage, a set of multiple data items ingested from a set of multiple data channels, where data items from each data channel of the set of multiple data channels correspond to a channel-specific data structure, transforming the set of multiple data items from a respective channel-specific data structure into a common data structure to obtain a set of multiple transformed data items that are stored in a second ephemeral data storage, storing, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads, generating, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model, and executing one or more actions based on generation of the set of multiple insights on the set of multiple transformed data items.

An apparatus for data processing is described. The apparatus may include one or more memories storing processor executable code, and one or more processors coupled with the one or more memories. The one or more processors may individually or collectively be operable to execute the code to cause the apparatus to store, in a first ephemeral data storage, a set of multiple data items ingested from a set of multiple data channels, where data items from each data channel of the set of multiple data channels correspond to a channel-specific data structure, transform the set of multiple data items from a respective channel-specific data structure into a common data structure to obtain a set of multiple transformed data items that are stored in a second ephemeral data storage, store, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads, generate, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model, and execute one or more actions based on generation of the set of multiple insights on the set of multiple transformed data items.

Another apparatus for data processing is described. The apparatus may include means for storing, in a first ephemeral data storage, a set of multiple data items ingested from a set of multiple data channels, where data items from each data channel of the set of multiple data channels correspond to a channel-specific data structure, means for transforming the set of multiple data items from a respective channel-specific data structure into a common data structure to obtain a set of multiple transformed data items that are stored in a second ephemeral data storage, means for storing, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads, means for generating, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model, and means for executing one or more actions based on generation of the set of multiple insights on the set of multiple transformed data items.

A non-transitory computer-readable medium storing code for data processing is described. The code may include instructions executable by one or more processors to store, in a first ephemeral data storage, a set of multiple data items ingested from a set of multiple data channels, where data items from each data channel of the set of multiple data channels correspond to a channel-specific data structure, transform the set of multiple data items from a respective channel-specific data structure into a common data structure to obtain a set of multiple transformed data items that are stored in a second ephemeral data storage, store, in a first data model and in association with each transformed data item of the set of multiple transformed data items, a channel-specific session and one or more channel-specific threads corresponding to the channel-specific session, where a respective channel-specific session corresponds to metadata representing a grouping of channel-specific threads, generate, in accordance with a stored configuration and via one or more machine learning models of a set of multiple machine learning models, a set of multiple insights on the set of multiple transformed data items stored within the first data model, a respective insight being associated with the channel-specific session and the one or more channel-specific threads of a respective transformed data item, where the set of multiple insights are stored within the first data model, and execute one or more actions based on generation of the set of multiple insights on the set of multiple transformed data items.

Some examples of the method, apparatus, and non-transitory computer-readable medium described herein may further include operations, features, means, or instructions for obtaining, from a user, a respective data item from a respective data channel, the respective data item being obtained directly from the user or indirectly from the user via the respective data channel, where the set of multiple data items may be stored within the first ephemeral data storage based at least in part obtaining the respective data item.

Some examples of the method, apparatus, and non-transitory computer-readable medium described herein may further include operations, features, means, or instructions for mapping the set of multiple data items from the set of multiple data channels to a first set of multiple channel-specific data objects, where storing the set of multiple data items in the first ephemeral data storage includes storing the first set of multiple channel-specific data objects.

In some examples of the method, apparatus, and non-transitory computer-readable medium described herein, transforming the set of multiple data items may include operations, features, means, or instructions for transforming the first set of multiple channel-specific data objects into a second set of multiple channel-specific data objects, the second set of multiple channel-specific data objects including the set of multiple data items within the common data structure.

Some examples of the method, apparatus, and non-transitory computer-readable medium described herein may further include operations, features, means, or instructions for receiving a first configuration that includes instructions for the generation of the set of multiple insights via the one or more machine learning models of the set of multiple machine learning models, where the stored configuration includes the first configuration.

In some examples of the method, apparatus, and non-transitory computer-readable medium described herein, transforming the set of multiple data items may include operations, features, means, or instructions for transforming, via a set of multiple channel-specific transformers, the set of multiple data items into the common data structure to obtain the set of multiple transformed data items.

In some examples of the method, apparatus, and non-transitory computer-readable medium described herein, generating the set of multiple insights may include operations, features, means, or instructions for receiving, from the first data model, an application programming interface (API) request message to trigger an insight extraction service to generate the set of multiple insights, where the set of multiple insights may be stored within the first data model based on the API request message.

In some examples of the method, apparatus, and non-transitory computer-readable medium described herein, generating the set of multiple insights may include operations, features, means, or instructions for storing, within a first message queue, the set of multiple transformed data items associated with respective channel-specific sessions and respective one or more channel-specific threads of respective transformed data items, storing, within a second message queue, the set of multiple transformed data items, the second message queue being associated with the one or more machine learning models of the set of multiple machine learning models configured for generation of the set of multiple insights, obtaining, from the one or more machine learning models of the set of multiple machine learning models, the set of multiple insights on the set of multiple transformed data items, and storing, in the first data model, the set of multiple insights based on obtaining the set of multiple insights.

In some examples of the method, apparatus, and non-transitory computer-readable medium described herein, executing the one or more actions may include operations, features, means, or instructions for displaying, via a first user interface, the set of multiple insights on the set of multiple transformed data items, the first user interface including one or more interactive elements that may be associated with respective insights of the set of multiple insights.

In some examples of the method, apparatus, and non-transitory computer-readable medium described herein, executing the one or more actions may include operations, features, means, or instructions for receiving, from a first user, a request for an insight on a respective set of data, where the one or more actions may be executed automatically based on reception of the request.

In some examples of the method, apparatus, and non-transitory computer-readable medium described herein, executing the one or more actions may include operations, features, means, or instructions for generating, automatically in response to the generation of the set of multiple insights, a summary of the set of multiple insights, an electronic message associated with the set of multiple insights, or both.

In some examples of the method, apparatus, and non-transitory computer-readable medium described herein, executing the one or more actions may include operations, features, means, or instructions for executing the one or more actions based on one or more insights of the set of multiple insights satisfying a threshold associated with the one or more insights, where the summary of the set of multiple insights, the electronic message, or both may be generated based on the one or more insights satisfying the threshold.

In some examples of the method, apparatus, and non-transitory computer-readable medium described herein, the set of multiple machine learning models includes a large language model (LLM), a natural language processing (NLP) model, or both.

In some examples of the method, apparatus, and non-transitory computer-readable medium described herein, the set of multiple insights may be associated with sentiment analysis, target sentiments, key phrases, entity detection, topic clustering, or any combination thereof.

In some examples of the method, apparatus, and non-transitory computer-readable medium described herein, a respective machine learning model used for the generation of a respective insight of the set of multiple insights on a respective transformed data item of the set of multiple transformed data items may be based on with a type of insight being generated for the respective transformed data item.

The following provides an overview of aspects of the present disclosure:
Aspect 1: A method for data processing, comprising: storing, in a first ephemeral data storage, a plurality of data items ingested from a plurality of data channels, wherein data items from each data channel of the plurality of data channels correspond to a channel-specific data structure; transforming the plurality of data items from a respective channel-specific data structure into a common data structure to obtain a plurality of transformed data items that are stored in a second ephemeral data storage; storing, in a first data model and in association with each transformed data item of the plurality of transformed data items, a channel-specific session and one or more channel-specific threads corresponding to the channel-specific session, wherein a respective channel-specific session corresponds to metadata representing a grouping of channel-specific threads; generating, in accordance with a stored configuration and via one or more machine learning models of a plurality of machine learning models, a plurality of insights on the plurality of transformed data items stored within the first data model, a respective insight being associated with the channel-specific session and the one or more channel-specific threads of a respective transformed data item, wherein the plurality of insights are stored within the first data model; and executing one or more actions based at least in part on generation of the plurality of insights on the plurality of transformed data items.
Aspect 2: The method of aspect 1, further comprising: obtaining, from a user, a respective data item from a respective data channel, the respective data item being obtained directly from the user or indirectly from the user via the respective data channel, wherein the plurality of data items are stored within the first ephemeral data storage based at least in part obtaining the respective data item.
Aspect 3: The method of any of aspects 1 through 2, further comprising: mapping the plurality of data items from the plurality of data channels to a first plurality of channel-specific data objects, wherein storing the plurality of data items in the first ephemeral data storage comprises storing the first plurality of channel-specific data objects.
Aspect 4: The method of aspect 3, wherein transforming the plurality of data items comprises: transforming the first plurality of channel-specific data objects into a second plurality of channel-specific data objects, the second plurality of channel-specific data objects comprising the plurality of data items within the common data structure.
Aspect 5: The method of any of aspects 1 through 4, further comprising: receiving a first configuration that comprises instructions for the generation of the plurality of insights via the one or more machine learning models of the plurality of machine learning models, wherein the stored configuration comprises the first configuration.
Aspect 6: The method of any of aspects 1 through 5, wherein transforming the plurality of data items comprises: transforming, via a plurality of channel-specific transformers, the plurality of data items into the common data structure to obtain the plurality of transformed data items.
Aspect 7: The method of any of aspects 1 through 6, wherein generating the plurality of insights comprises: receiving, from the first data model, an application programming interface (API) request message to trigger an insight extraction service to generate the plurality of insights, wherein the plurality of insights are stored within the first data model based at least in part on the API request message.
Aspect 8: The method of any of aspects 1 through 7, wherein generating the plurality of insights comprises: storing, within a first message queue, the plurality of transformed data items associated with respective channel-specific sessions and respective one or more channel-specific threads of respective transformed data items; storing, within a second message queue, the plurality of transformed data items, the second message queue being associated with the one or more machine learning models of the plurality of machine learning models configured for generation of the plurality of insights; obtaining, from the one or more machine learning models of the plurality of machine learning models, the plurality of insights on the plurality of transformed data items; and storing, in the first data model, the plurality of insights based at least in part on obtaining the plurality of insights.
Aspect 9: The method of any of aspects 1 through 8, wherein executing the one or more actions comprises: displaying, via a first user interface, the plurality of insights on the plurality of transformed data items, the first user interface comprising one or more interactive elements that are associated with respective insights of the plurality of insights.
Aspect 10: The method of any of aspects 1 through 9, wherein executing the one or more actions comprises: receiving, from a first user, a request for an insight on a respective set of data, wherein the one or more actions are executed automatically based at least in part on reception of the request.
Aspect 11: The method of any of aspects 1 through 10, wherein executing the one or more actions comprises: generating, automatically in response to the generation of the plurality of insights, a summary of the plurality of insights, an electronic message associated with the plurality of insights, or both.
Aspect 12: The method of aspect 11, wherein executing the one or more actions comprises: executing the one or more actions based at least in part on one or more insights of the plurality of insights satisfying a threshold associated with the one or more insights, wherein the summary of the plurality of insights, the electronic message, or both are generated based at least in part on the one or more insights satisfying the threshold.
Aspect 13: The method of any of aspects 1 through 12, wherein the plurality of machine learning models comprises a large language model (LLM), a natural language processing (NLP) model, or both.
Aspect 14: The method of any of aspects 1 through 13, wherein the plurality of insights are associated with sentiment analysis, target sentiments, key phrases, entity detection, topic clustering, or any combination thereof.
Aspect 15: The method of any of aspects 1 through 14, wherein a respective machine learning model used for the generation of a respective insight of the plurality of insights on a respective transformed data item of the plurality of transformed data items is based at least in part on with a type of insight being generated for the respective transformed data item.
Aspect 16: An apparatus for data processing, comprising one or more memories storing processor-executable code, and one or more processors coupled with the one or more memories and individually or collectively operable to execute the code to cause the apparatus to perform a method of any of aspects 1 through 15.
Aspect 17: An apparatus for data processing, comprising at least one means for performing a method of any of aspects 1 through 15.
Aspect 18: A non-transitory computer-readable medium storing code for data processing, the code comprising instructions executable by one or more processors to perform a method of any of aspects 1 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
storing, in a first ephemeral data storage, a plurality of data items ingested from a plurality of data channels, wherein data items from each data channel of the plurality of data channels correspond to a channel-specific data structure;
transforming the plurality of data items from a respective channel-specific data structure into a common data structure to obtain a plurality of transformed data items that are stored in a second ephemeral data storage;
storing, in a first data model and in association with each transformed data item of the plurality of transformed data items, a channel-specific session and one or more channel-specific threads corresponding to the channel-specific session, wherein a respective channel-specific session corresponds to metadata representing a grouping of channel-specific threads;
generating, in accordance with a stored configuration and via one or more machine learning models of a plurality of machine learning models, a plurality of insights on the plurality of transformed data items stored within the first data model, a respective insight being associated with the channel-specific session and the one or more channel-specific threads of a respective transformed data item, wherein the plurality of insights are stored within the first data model; and
executing one or more actions based at least in part on generation of the plurality of insights on the plurality of transformed data items.

2. The method of claim 1, further comprising:
obtaining, from a user, a respective data item from a respective data channel, the respective data item being obtained directly from the user or indirectly from the user via the respective data channel, wherein the plurality of data items are stored within the first ephemeral data storage based at least in part obtaining the respective data item.

3. The method of claim 1, further comprising:
mapping the plurality of data items from the plurality of data channels to a first plurality of channel-specific data objects, wherein storing the plurality of data items in the first ephemeral data storage comprises storing the first plurality of channel-specific data objects.

4. The method of claim 3, wherein transforming the plurality of data items comprises:
transforming the first plurality of channel-specific data objects into a second plurality of channel-specific data objects, the second plurality of channel-specific data objects comprising the plurality of data items within the common data structure.

5. The method of claim 1, further comprising:
receiving a first configuration that comprises instructions for the generation of the plurality of insights via the one or more machine learning models of the plurality of machine learning models, wherein the stored configuration comprises the first configuration.

6. The method of claim 1, wherein transforming the plurality of data items comprises:
transforming, via a plurality of channel-specific transformers, the plurality of data items into the common data structure to obtain the plurality of transformed data items.

7. The method of claim 1, wherein generating the plurality of insights comprises:
receiving, from the first data model, an application programming interface (API) request message to trigger an insight extraction service to generate the plurality of insights, wherein the plurality of insights are stored within the first data model based at least in part on the API request message.

8. The method of claim 1, wherein generating the plurality of insights comprises:
storing, within a first message queue, the plurality of transformed data items associated with respective channel-specific sessions and respective one or more channel-specific threads of respective transformed data items;
storing, within a second message queue, the plurality of transformed data items, the second message queue being associated with the one or more machine learning models of the plurality of machine learning models configured for generation of the plurality of insights;
obtaining, from the one or more machine learning models of the plurality of machine learning models, the plurality of insights on the plurality of transformed data items; and
storing, in the first data model, the plurality of insights based at least in part on obtaining the plurality of insights.

9. The method of claim 1, wherein executing the one or more actions comprises:
displaying, via a first user interface, the plurality of insights on the plurality of transformed data items, the first user interface comprising one or more interactive elements that are associated with respective insights of the plurality of insights.

10. The method of claim 1, wherein executing the one or more actions comprises:
receiving, from a first user, a request for an insight on a respective set of data, wherein the one or more actions are executed automatically based at least in part on reception of the request.

11. The method of claim 1, wherein executing the one or more actions comprises:
generating, automatically in response to the generation of the plurality of insights, a summary of the plurality of insights, an electronic message associated with the plurality of insights, or both.

12. The method of claim 11, wherein executing the one or more actions comprises:
executing the one or more actions based at least in part on one or more insights of the plurality of insights satisfying a threshold associated with the one or more insights, wherein the summary of the plurality of insights, the electronic message, or both are generated based at least in part on the one or more insights satisfying the threshold.

13. The method of claim 1, wherein the plurality of machine learning models comprises a large language model (LLM), a natural language processing (NLP) model, or both.

14. The method of claim 1, wherein the plurality of insights are associated with sentiment analysis, target sentiments, key phrases, entity detection, topic clustering, or any combination thereof.

15. The method of claim 1, wherein a respective machine learning model used for the generation of a respective insight of the plurality of insights on a respective transformed data item of the plurality of transformed data items is based at least in part on with a type of insight being generated for the respective transformed data item.

16. An apparatus for data processing, comprising:
one or more memories storing processor-executable code; and
one or more processors coupled with the one or more memories and individually or collectively operable to execute the code to cause the apparatus to:
store, in a first ephemeral data storage, a plurality of data items ingested from a plurality of data channels, wherein data items from each data channel of the plurality of data channels correspond to a channel-specific data structure;
transform the plurality of data items from a respective channel-specific data structure into a common data structure to obtain a plurality of transformed data items that are stored in a second ephemeral data storage;
store, in a first data model and in association with each transformed data item of the plurality of transformed data items, a channel-specific session and one or more channel-specific threads corresponding to the channel-specific session, wherein a respective channel-specific session corresponds to metadata representing a grouping of channel-specific threads;
generate, in accordance with a stored configuration and via one or more machine learning models of a plurality of machine learning models, a plurality of insights on the plurality of transformed data items stored within the first data model, a respective insight being associated with the channel-specific session and the one or more channel-specific threads of a respective transformed data item, wherein the plurality of insights are stored within the first data model; and
execute one or more actions based at least in part on generation of the plurality of insights on the plurality of transformed data items.

17. The apparatus of claim 16, wherein the one or more processors are individually or collectively further operable to execute the code to cause the apparatus to:
map the plurality of data items from the plurality of data channels to a first plurality of channel-specific data objects, wherein storing the plurality of data items in the first ephemeral data storage comprises storing the first plurality of channel-specific data objects.

18. The apparatus of claim 16, wherein, to transform the plurality of data items, the one or more processors are individually or collectively operable to execute the code to cause the apparatus to:
transform, via a plurality of channel-specific transformers, the plurality of data items into the common data structure to obtain the plurality of transformed data items.

19. The apparatus of claim 16, wherein, to generate the plurality of insights, the one or more processors are individually or collectively operable to execute the code to cause the apparatus to:
store, within a first message queue, the plurality of transformed data items associated with respective channel-specific sessions and respective one or more channel-specific threads of respective transformed data items;
store, within a second message queue, the plurality of transformed data items, the second message queue being associated with the one or more machine learning models of the plurality of machine learning models configured for generation of the plurality of insights;
obtain, from the one or more machine learning models of the plurality of machine learning models, the plurality of insights on the plurality of transformed data items; and
store, in the first data model, the plurality of insights based at least in part on obtaining the plurality of insights.

20. A non-transitory computer-readable medium storing code for data processing, the code comprising instructions executable by one or more processors to:
store, in a first ephemeral data storage, a plurality of data items ingested from a plurality of data channels, wherein data items from each data channel of the plurality of data channels correspond to a channel-specific data structure;
transform the plurality of data items from a respective channel-specific data structure into a common data structure to obtain a plurality of transformed data items that are stored in a second ephemeral data storage;
store, in a first data model and in association with each transformed data item of the plurality of transformed data items, a channel-specific session and one or more channel-specific threads corresponding to the channel-specific session, wherein a respective channel-specific session corresponds to metadata representing a grouping of channel-specific threads;
generate, in accordance with a stored configuration and via one or more machine learning models of a plurality of machine learning models, a plurality of insights on the plurality of transformed data items stored within the first data model, a respective insight being associated with the channel-specific session and the one or more channel-specific threads of a respective transformed data item, wherein the plurality of insights are stored within the first data model; and
execute one or more actions based at least in part on generation of the plurality of insights on the plurality of transformed data items.
